(19) United States
(12) Patent Application Publication
(10) Pub. No.: US 2026/0167321 A1
(43) Pub. Date: Jun. 18, 2026

(54) DEVICE AND METHOD FOR ASSISTING IN MONITORING THE MISSION STATUS OF AT LEAST ONE AIRCRAFT

(71) Applicant: THALES, Meudon (FR)

(72) Inventors: Quentin PESTRE-SORGE, MERIGNAC (FR); Aurélien THIRIET, MERIGNAC (FR); Jaime DIAZ PINEDA, MERIGNAC (FR)

(21) Appl. No.: 19/409,944

(22) Filed: Dec. 5, 2025

(30) Foreign Application Priority Data
Dec. 13, 2024 (FR) FR2414049

(51) Int. Cl. B64C 13/18; B64D 45/00

(52) U.S. Cl. CPC B64C 13/18; B64D 45/00

(57) ABSTRACT

A method for assisting in monitoring the mission status of at least one aircraft, through the monitoring of at least one operational criterion during the execution of the mission, includes the following steps: determination of a polynomial function representing the at least one operational criterion, each monomial of which is a product of constants and/or variables, each variable being a characteristic quantity of a set of characteristic quantity(ies) associated with the operational criterion; by partial derivative of the polynomial function, determination of the impact of the variation of each characteristic quantity on the value of the operational criterion; and return of the impact of each characteristic quantity to an operator of the aircraft, conducive to using the impact to identify at least one source of execution anomaly of the mission.

This invention relates to a method for assisting in monitoring the mission status of at least one aircraft, in piloting an aircraft, through the monitoring of at least one operational criterion of said mission of said at least one aircraft during the execution of said mission, the method being implemented by an electronic device for assisting in monitoring the mission status of at least one aircraft.

The invention also relates to a computer program including software instructions that implement such a method for assisting in monitoring the mission status of at least one aircraft, when executed by a computer.

The invention also relates to an electronic device for assisting in monitoring the mission status of at least one aircraft, and an aircraft comprising such a device for assisting in monitoring the mission status of at least one aircraft.

The invention more particularly relates to an airplane, while being applicable to any type of aircraft, such as a helicopter or a drone.

The invention relates to the field of tactical assistance to an aircraft pilot to plan/replan an avionic mission, specifically to reduce the cognitive load for the aircraft pilot during the execution of said aircraft mission.

From the document whose filing number is FR 2303810, a method and associated electronic device for assisting in piloting an aircraft are already known, which enable reducing the cognitive load for the aircraft pilot through the monitoring of at least one operational criterion of said mission of said at least one aircraft during the execution of said mission. This solution specifically enables the operator to realize that the operational criteria are deteriorating or improving.

However, identifying the origin of the change remains a task for the operator, which involves an additional cognitive load, especially in complex environments.

The aim of the invention is then to propose a solution to assist in identifying the origin of a change in the value of the operational criteria of a mission.

To this end, the invention aims at a method for assisting in monitoring the mission status of at least one aircraft through monitoring at least one operational criterion of a mission of said at least one aircraft during the execution of said mission, the method being implemented by an electronic device for assisting in monitoring the mission status of at least one aircraft and, for each operational criterion, comprising the following steps:
determination of a polynomial function representing said at least one operational criterion, each monomial of which is a product of constants and/or variables, each variable being a characteristic quantity of a set of N characteristic quantity(ies) associated with said operational criterion;
by partial derivative of said polynomial function, determination of the impact of the variation of each characteristic quantity of said set associated with said operational criterion on the value of said operational criterion;
return of the impact of each characteristic quantity, via a human-machine interface, to an operator of said aircraft, conducive to using said impact to identify at least one source of execution anomaly of said mission.

The method for assisting in monitoring the mission status of at least one aircraft according to the invention thus enables helping the pilot to assess the chances of success of the mission of said at least one aircraft or the need to re-plan it, by improving their understanding of the impact of each characteristic quantity associated with the monitored operational criterion throughout the mission in progress.

The piloting assistance method according to the invention thus provides significant assistance to the pilot and reduces their cognitive load necessary to perform a diagnosis on the chances of success of the mission, and to identify the source of problems occurring during the mission, especially in the presence of a changing environment.

The solution according to the present invention complements the aforementioned solution of the document whose filing number is FR 2303810, by providing the pilot with keys (i.e. the returned impacts) to identify the root cause or causes of an operational criterion variation, detected via the aforementioned solution of the document whose filing number is FR 2303810, which further reduces the cognitive load of the operator (e.g. the pilot).

According to other advantageous aspects of the invention, the method for assisting in monitoring the mission status of at least one aircraft comprises one or more of the following features, taken individually or in any technically possible combination:
the impact of the variation of each characteristic quantity of said set associated with said operational criterion on the value of said operational criterion depends on the sign and value of the partial derivative associated with said characteristic quantity;
the method further comprises:
   the receipt of at least one piloting intention to be monitored and associated with said operational criterion;
   based on said impact of each characteristic quantity of said set associated with said operational criterion and said at least one intention, the determination (60) of the type of variation of said characteristic quantity to be monitored according to a reference variation value, the type of variation being an increase or decrease;
   the return, via said human-machine interface, to an operator of said aircraft, of said type of variation, to be returned to the operator for each characteristic quantity of said set associated with said operational criterion;
the method further comprises:
   the determination of a discrepancy between a current value of the operational criterion and a previous value of said operational criterion, each current or previous value of said operational criterion being obtained from each determined value of characteristic quantity associated with said operational criterion, through the implementation of an artificial intelligence algorithm;
   from the value of said discrepancy and said impact of each characteristic quantity of said set associated with said operational criterion, identification of at least one of the characteristic quantities associated with said operational criterion conducive to being responsible for said discrepancy.
   the method further comprises:
      the construction and return of a visual representation corresponding to the projection of the aircraft's trajectory in an M-dimensional space, each point of which is associated with a cost value relative to said operational criterion, a correspondence being established beforehand between each cost value and the value(s) of each characteristic quantity of said set associated with said operational criterion;
      from said visual representation, identification of trajectory portions impacted by said at least one of the characteristic quantities associated with said operational criterion conducive to being responsible for said discrepancy;
   the artificial intelligence algorithm includes a fuzzy logic decision tree, the fuzzy logic decision tree comprising at least one fuzzy inference system, each fuzzy inference system being configured to receive at least one determined value of characteristic quantity, as input, and to deliver a unit evaluation value, as output; for each fuzzy inference system, a correspondence between input(s) and output being established by fuzzy logic; the value of the operational criterion then being estimated from the unit evaluation value(s) calculated for the set of characteristic quantity(ies) associated with said operational criterion, and said polynomial function, representing said at least one operational criterion, is equivalent to said at least one fuzzy inference system of said fuzzy logic decision tree;
   the artificial intelligence algorithm includes a radial basis function fuzzy network comprising at least one fuzzy inference system, each fuzzy inference system being configured to receive at least one determined value of characteristic quantity, as input, and to deliver a unit evaluation value, as output; for each fuzzy inference system, a correspondence between input(s) and output being established by fuzzy logic; the value of the operational criterion then being estimated from the unit evaluation value(s) calculated for the set of characteristic quantity(ies) associated with said operational criterion,
and wherein said polynomial function representing said at least one operational criterion is equivalent to said at least one fuzzy inference system of said radial basis function fuzzy network.

The invention also relates to a computer program including software instructions that implement a method for assisting in monitoring the mission status of at least one aircraft as defined above, when executed by a computer.

The invention also relates to an electronic device for assisting in monitoring the mission status of at least one aircraft through the monitoring of at least one operational criterion of a mission of said at least one aircraft during the execution of said mission, the device comprising:
a first determination module, configured to determine a polynomial function representing said at least one operational criterion, each monomial of which is a product of constants and/or variables, each variable being a characteristic quantity of a set of N characteristic quantity(ies) associated with said operational criterion;
a second determination module, configured to determine, by partial derivative of said polynomial function, the impact of the variation of each characteristic quantity of said set associated with said operational criterion on the value of said operational criterion;
a return module, configured to return the impact of each characteristic quantity, via a human-machine interface, to an operator of said aircraft, conducive to using said impact to optimize the piloting of said aircraft.

The invention also aims at an aircraft comprising an electronic device for assisting in monitoring the mission status of at least one aircraft, the electronic device for assisting in monitoring being as defined above.

These features and advantages of the invention will become clearer upon reading the following description, given solely by way of non-limiting example, and made with reference to the appended drawings, wherein:

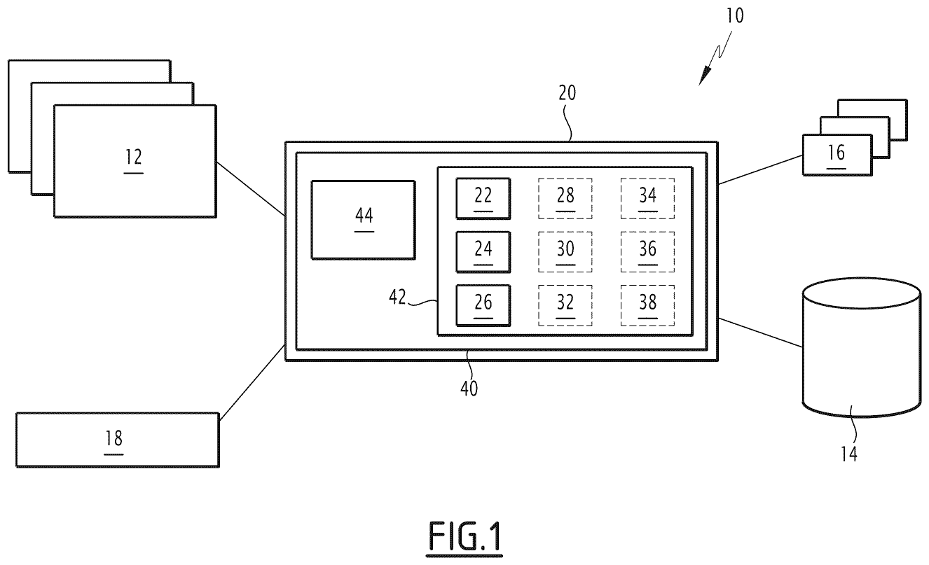

FIG. 1 is a schematic representation of an aircraft comprising an electronic device for assisting in monitoring the mission status of at least one aircraft according to the invention, connected to avionic systems, to one or more sensors, to a database, as well as to a display system;

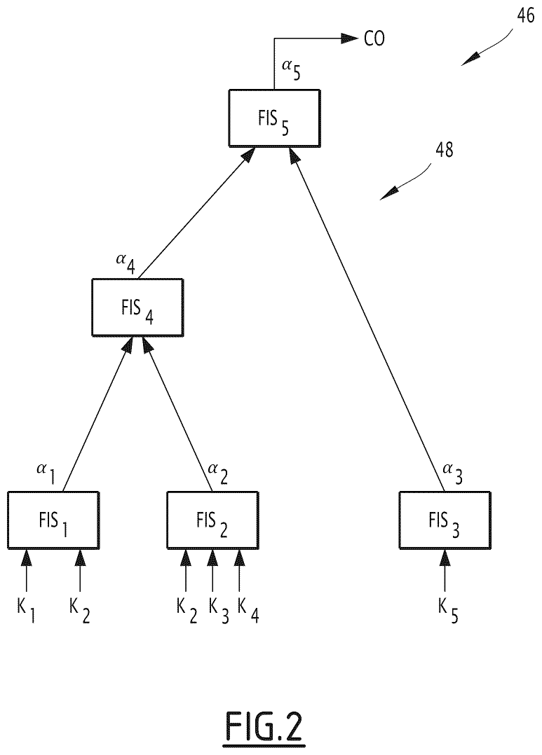

FIG. 2 is a schematic representation of a fuzzy logic decision tree included in an artificial intelligence algorithm, implemented by the electronic device for assisting in monitoring the mission status of at least one aircraft according to the invention of FIG. 1; and

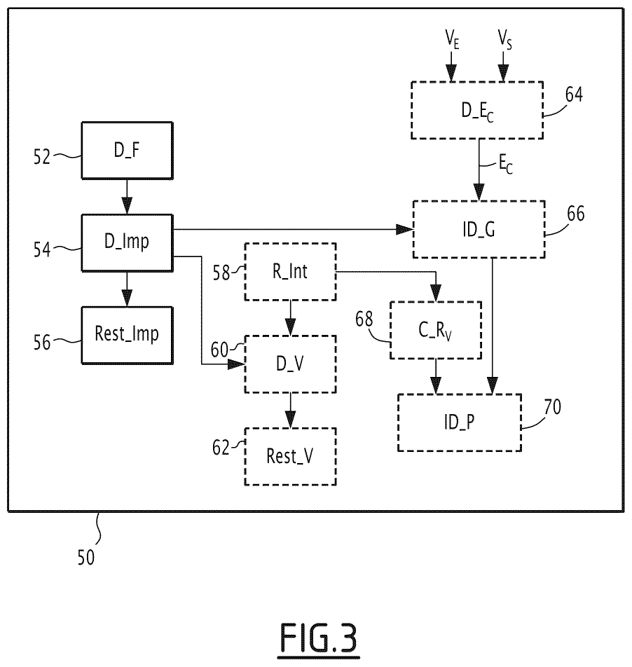

FIG. 3 is a flowchart of a method for assisting in monitoring the mission status of at least one aircraft according to the invention, the method being implemented by the device for assisting in monitoring the mission status of at least one aircraft of FIG. 1.

In FIG. 1, an aircraft 10 comprises several avionic systems 12, one or more databases 14, several sensors 16, one or more display systems 18, and an electronic device 20 for assisting in monitoring the mission status of said aircraft connected to the avionic systems 12, to the database(s) 14, to the sensors 16, and to the display system(s) 18.

The aircraft 10 is an airplane such as a commercial airliner, for example. In a variant, the aircraft 10 is a helicopter, a remotely piloted drone or an autonomous aircraft without an operator. The skilled person will observe that in the case where the aircraft 10 is an autonomous aircraft without an operator, it preferably does not comprise a display system.

Each avionic system 12 is embedded onboard the aircraft 10, is known per se and is configured to implement one or more respective avionic functions.

Each avionic system 12 is capable of transmitting, to the electronic device 20 for assisting in monitoring the mission status of at least one aircraft, various avionic data, such as so-called “aircraft” data, such as the position, speed, acceleration, orientation, heading, or altitude of the aircraft 10, and/or so-called “navigation” such as a flight plan, an estimated arrival time, a number of passengers.

Each avionic system 12 is, for example, chosen from the group consisting of: a flight management system, also called FMS; a flight guidance system, or FG; a flight control system, or FCS; a satellite positioning system, such as a GPS system (Global Positioning System); an inertial reference system, also called IRS; an instrument landing system ILS or a microwave landing system MLS; an active runway overrun prevention system, also called ROPS; and a radio altimeter, also noted RA.

Optionally, some avionic systems 12 are also capable of receiving instructions, or even commands, via (i.e. through) a human-machine interface associated with said electronic device 20 for assisting in monitoring the mission status of at least one aircraft. These avionic systems 12 are capable of receiving instructions, such as:
the flight control system, also noted FCS or FBW (Fly By Wire), to act on a set of control surfaces and actuators of the aircraft. In the case of a fixed-wing aircraft, the control surfaces are the ailerons, the elevator or the rudder, for example. In the case of a rotary-wing aircraft, the control surfaces are the collective pitch, the cyclic pitch, or the tail rotor pitch, for example;
an engine control system, also noted ECU (Engine Control Unit) to vary the energy delivered by an engine of the aircraft, such as a jet engine, a turboprop, or a turbine;
at least one guidance system, such as an automatic flight control system, also noted AFCS (Auto-Flight Control System), also called autopilot and noted PA or AP (Automatic Pilot), or such as the flight management system (FMS) of the aircraft.

Each database 14 is optional, known per se and chosen, for example, from the group consisting of:
a navigation database, also called NAVDB (NAVigation Data Base), specifically containing data relating to prohibited flight spaces or zones, data relating to runways on which the aircraft 10 is likely to land, this data typically being a position of a runway threshold, a runway orientation, a runway length, an altitude, or a decision point, etc.;
a terrain elevation database, containing information relating to the height and altitude of the Earth's surface;
a performance database, also called PERFDB (PERFormance Data Base), containing information on the performance of the aircraft 10 such as speed, fuel consumption, altitude, range, etc.;
a maintenance database, containing information on repairs, maintenance, and inspections performed on the aircraft;
a passenger database, containing information on passengers, such as their name, age, nationality, passport number, etc.; and
a weather database, containing information on weather conditions such as temperature, pressure, wind speed and direction, visibility, etc. This data is used for flight planning and passenger safety.

These databases are typically interconnected and fed at least in part by the sensors 16.

In the example of FIG. 1, the databases 14 are databases external to the electronic device 20 for assisting in monitoring the mission status of at least one aircraft. In a variant, not shown, the databases 14 are at least partially internal to the electronic device 20 for assisting in monitoring the mission status of at least one aircraft.

The sensors 16 are capable of measuring different quantities associated with the aircraft 10 and/or associated with the environment of the aircraft 10, and include, for example, at least one sensor among: a laser remote sensing device, better known as lidar (light detection and ranging); a radar (radio detection and ranging); a laser (light amplification by stimulated emission of radiation); a rangefinder; a radio altimeter; an accelerometer; an inertial measurement unit, also called IMU (Inertial Measurement Unit); a Doppler effect sensor; a satellite positioning sensor, such as a GPS sensor (Global Positioning System), a Galileo sensor, a Glonass sensor; one or more stereoscopic cameras; and a sensor of atmospheric data such as pressure, temperature.

Each electronic sensor 16 is known per se, and the data measured by each sensor 16 is intended to be acquired by the electronic device 20 for assisting in monitoring the mission status of at least one aircraft, to which it is connected.

The display system(s) 18 are, for example, a head-down display system and/or a head-up display system, also called HUD (Head-Up Display). The head-down display system is, for example, a navigation data display system (Navigation Display). In a variant or in addition, the display system 18 is a remote display system, in particular an external display system to the aircraft 10, such as a display system in a ground station, or even the remote control or vision glasses of a drone operator.

The electronic device for assisting in monitoring the mission status of at least one aircraft 20 is intended to be embedded onboard the aircraft 10 when the aircraft 10 is an airplane or a helicopter. In a variant, the electronic device 20 for assisting in monitoring the mission status of at least one aircraft is intended to be installed on the ground, while being connected to the avionic systems 12 embedded onboard the aircraft 10, when the aircraft 10 is a remotely piloted drone or an autonomous aircraft without an operator.

The electronic device 20 for assisting in monitoring the mission status of at least one aircraft is intended to provide assistance to the aircraft pilot 10 by performing a monitoring of at least one operational criterion of said mission of said at least one aircraft 10 during the execution of said mission, which thus enables reducing the cognitive load for the pilot. This monitoring is preferably performed regularly, by regularly estimating a new value of each monitored operational criterion. Each operational criterion is chosen from the group consisting of: safety, punctuality, comfort, and ecology, for example.

In addition, the electronic device 20 for assisting in monitoring the mission status of at least one aircraft is configured to perform the monitoring of several operational criteria at once, specifically of several operational criteria among the aforementioned operational criteria, and, for example, of all the operational criteria among the group consisting of: safety, punctuality, comfort, and ecology. According to this addition, the electronic device 20 for assisting in monitoring the mission status of at least one aircraft is preferably configured to perform this monitoring of several operational criteria simultaneously. In other words, the plurality of operational criteria is then monitored simultaneously, said operational criteria being monitored in parallel with each other.

In the example of FIG. 1, the electronic device for assisting in monitoring the mission status of at least one aircraft 20 is an autonomous electronic device, external to the avionic systems 12, the database(s) 14, the sensors 16, and the display system(s) 18. In other words, in this example, the electronic device 20 for assisting in monitoring the mission status of at least one aircraft is distinct and separate from each of the avionic systems 12. In a variant, not shown, the electronic device 20 for assisting in monitoring the mission status of at least one aircraft is integrated into one of the avionic systems 12, i.e. comprised in one of the avionic systems 12, such as the flight management system or FMS.

The electronic device 20 for assisting in monitoring the mission status of at least one aircraft comprises a first determination module 22, configured to determine a polynomial function representing said at least one operational criterion, each monomial of which is a product of constants and/or variables, each variable being a characteristic quantity K1, K2, . . . , KN of a set of N characteristic quantity(ies) associated with said operational criterion CO, with N being an integer.

The electronic device 20 for assisting in monitoring the mission status of at least one aircraft also comprises a second determination module 24, configured to determine, by partial derivative of said polynomial function, the impact of the variation of each characteristic quantity of said set associated with said operational criterion CO on the value of said operational criterion CO.

The electronic device 20 for assisting in monitoring the mission status of at least one aircraft also comprises a return module 26, configured to return the impact of each characteristic quantity, via a human-machine interface, to an operator of said aircraft, conducive to using said impact to optimize the piloting of said aircraft.

Such a return module 26 is conducive to visually returning said impact specifically by using a human-machine interface corresponding to one of the aforementioned display systems 18, or audibly, via a human-machine interface comprising a microphone.

Optionally (represented in dotted lines), the electronic device 20 for assisting in monitoring the mission status of at least one aircraft also comprises a receipt module 28 of at least one piloting intention to be monitored and associated with said operational criterion CO, specifically via the aforementioned human-machine interface.

According to this optional addition, the electronic device 20 for assisting in monitoring the mission status of at least one aircraft also comprises a third determination module 30, configured to determine, based on said impact of each characteristic quantity of said set associated with said operational criterion CO and said at least one piloting intention, the type of variation of said characteristic quantity to be monitored according to a reference variation value, with the type of variation being an increase or decrease.

Still according to this optional addition, the return module 26 is then also configured to return said type of variation via said human-machine interface to an operator of said aircraft, to be returned to the operator for each characteristic quantity of said set associated with said operational criterion CO.

According to another optional addition (conducive to being combined with the previous optional addition), the electronic device 20 for assisting in monitoring the mission status of at least one aircraft also comprises a fourth determination module 32, configured to determine a discrepancy between a current value of the operational criterion CO and a previous value of said operational criterion CO, with each current or previous value of said operational criterion CO being obtained from each determined value of characteristic quantity K1, K2, . . . , KN associated with said operational criterion CO, through the implementation of an artificial intelligence algorithm 26.

According to a preferred example, the fourth determination module 32 is conducive to implementing the aforementioned solution of the document whose filing number is FR 2303810 to obtain the current value and the previous value of said operational criterion CO. In other words, the aforementioned solution of the document whose filing number is FR 2303810 is conducive to being used twice, a first time to determine the previous value of said operational criterion CO, then a second time to reevaluate this value and obtain the current value of said operational criterion CO specifically following a change in the mission context or the environment of said aircraft.

The modification (i.e. the change) of the environment of the aircraft 10 is a modification of the meteorological environment, for example, or even the receipt of a NOTAM message (NOTice to AirMen), i.e. a message to air navigators, generally published by government air navigation control agencies to inform pilots of infrastructure developments.

Still according to this other optional addition, the electronic device 20 for assisting in monitoring the mission status of at least one aircraft also comprises a first identification module 34, configured to identify, from the value of said discrepancy, and said impact of each characteristic quantity of said set associated with said operational criterion CO, with at least one of the characteristic quantities K1, K2, . . . , KN associated with said operational criterion CO conducive to being responsible for said discrepancy.

According to yet another optional addition (conducive to being combined with the two previous optional additions), the electronic device 20 for assisting in monitoring the mission status of at least one aircraft also comprises a construction and return module 36, configured to construct and return a visual representation corresponding to the projection of the aircraft's trajectory in an M-dimensional space, each point of which is associated with a cost value relative to said operational criterion, a correspondence being established beforehand between each cost value and the value(s) of each characteristic quantity of said set associated with said operational criterion CO.

According to this other optional addition, the electronic device 20 for assisting in monitoring the mission status of at least one aircraft also comprises a second identification module 38, configured to identify, from said visual representation, trajectory portions impacted by said at least one of the characteristic quantities K1, K2, . . . , KN associated with said operational criterion CO, conducive to being responsible for said discrepancy of said operational criterion CO.

In the example of FIG. 1, the electronic device 20 for assisting in monitoring the mission status of at least one aircraft comprises an information processing unit 40, formed of a memory 42 and a processor 44 associated with the memory 42, for example.

In the example of FIG. 1, the first determination module 22, the second determination module 24, and the return module 26, as well as optionally the receipt module 28, the third determination module 30, the fourth determination module 32, the first identification module 34, the construction module 36, and the second identification module 38 are each implemented in the form of software, or a software brick, executable by the processor 44. The memory 42 of the electronic device 20 for assisting in monitoring the mission status of at least one aircraft is thus capable of storing a first determination software, a second determination software; a return software. Optionally, the memory 42 of the electronic device 20 for assisting in monitoring the mission status of at least one aircraft is then capable of storing a receipt software, a third determination software, a fourth determination software, a first identification software, a construction software, and a second identification software. The processor 44 is then capable of executing each software of the first determination software, the second determination software, the return software, as well as optionally the receipt software, the third determination software, the fourth determination software, the first identification software, the construction software, and the second identification software.

When, in a variant, not shown, the database 14 is an internal database of the electronic device 20 for assisting in monitoring the mission status of at least one aircraft, it is typically conducive to being stored in a memory of the electronic device 20 for assisting in monitoring the mission status of at least one aircraft, such as the memory 42.

In a variant, not shown, the first determination module 22, the second determination module 24, and the return module 26, as well as optionally the receipt module 28, the third determination module 30, the fourth determination module 32, the first identification module 34, the construction module 36, and the second identification module 38, are each implemented in the form of a programmable logic component such as an FPGA (Field Programmable Gate Array); or even in the form of a dedicated integrated circuit, such as an ASIC (Application Specific Integrated Circuit).

When the electronic device 20 for assisting in monitoring the mission status of at least one aircraft is implemented in the form of one or more pieces of software, i.e. in the form of computer program, it is also conducive to being recorded on a medium, not shown, readable by a computer. The computer-readable medium is a medium capable of storing electronic instructions and being coupled to a bus of a computer system, for example. For example, the readable medium is an optical disk, a magneto-optical disk, a ROM memory, a RAM memory, any type of non-volatile memory (for example, EPROM, EEPROM, FLASH, NVRAM), a magnetic card, or an optical card. A computer program comprising software instructions is thus stored on the readable medium.

The first determination module 22 is configured to determine a polynomial function representing said at least one operational criterion, each monomial of which is a product of constants and/or variables, each variable being a characteristic quantity K1, K2, . . . , KN of a set of N characteristic quantity(ies) associated with said operational criterion CO.

Advantageously, for each operational criterion CO, the set of characteristic quantity(ies) associated with said operational criterion CO and/or the desired value of said operational criterion CO can be consulted and modified by a user.

The set of characteristic quantity(ies) K₁, K₂, K₃, K₄, K₅ associated with safety includes, for example, a lift of the aircraft 10, a ratio between the available fuel quantity and the necessary fuel quantity, and an indicator quantifying the compliance of the aircraft 10 with a flight plan.

The set of characteristic quantity(ies) K₁, K₂, K3, K₄, K₅ associated with punctuality typically includes an indicator quantifying a delay of the aircraft 10 upon arrival, a ratio of the number of passengers who missed a connection upon arrival to the total number of passengers on the delayed flight, an indicator quantifying a delay of a subsequent flight of the aircraft 10 due to the delay of the current flight of the aircraft 10.

The set of characteristic quantity(ies) K₁, K₂, K₃, K₄, K₅ associated with comfort includes, for example, a takeoff delay indicator, a number of vertical acceleration(s) exceeding a predefined threshold during the flight, and a cumulative duration of vertical acceleration(s) exceeding a predefined threshold during the flight.

The set of characteristic quantity(ies) K₁, K₂, K₃, K₄, K₅ associated with ecology typically includes a quantity of carbon dioxide emissions during the flight, an indicator of the use of favorable air currents to modify the trajectory of the aircraft 10 compared to an initially planned trajectory, a noise level generated on the ground during landing, a ratio between the quantity of carbon dioxide emitted during the flight and the number of passengers transported.

Each characteristic quantity K₁, K₂, K₃, K₄, K₅ is determined from at least one avionic variable, each avionic variable being acquired from a source chosen among the avionic systems 12, the database(s) 14, and the sensors 16. The determination of each characteristic quantity K₁, K₂, K₃, K₄, K₅ from at least one avionic variable is known per se.

As previously indicated, each current or previous value of said operational criterion (CO) is obtained from each determined value of characteristic quantity (K1, K2, . . . , KN) associated with said operational criterion (CO), through the implementation of an artificial intelligence algorithm.

According to a first variant, as illustrated by FIG. 2, the artificial intelligence algorithm 46 includes a fuzzy logic decision tree 48, the fuzzy logic decision tree preferably comprising at least one fuzzy inference system FIS1, FIS2, FIS3, FIS4, FIS5, each fuzzy inference system FIS1, FIS2, FIS3, FIS4, FIS5 being configured to receive at least one determined value of characteristic quantity K1, K2, K3, K4, K5 as input and to deliver a unit evaluation value as output; for each fuzzy inference system FIS1, FIS2, FIS3, FIS4, FIS5, a correspondence between input(s) and output being established by fuzzy logic; the value of the operational criterion CO thus being estimated from the unit evaluation value(s) calculated for the set of characteristic quantity(ies) associated with said operational criterion CO, and said polynomial function representing said at least one operational criterion is equivalent to said at least one fuzzy inference system of said fuzzy logic decision tree.

The fuzzy logic decision tree 48, also called GFT (Generalized Fuzzy Tree) enables making decisions also with uncertain or imprecise data. Unlike traditional decision trees that use binary rules to make decisions (true/false), the fuzzy logic decision tree 48 uses linguistic variables to represent concepts such as “very likely” or “somewhat likely.”

The fuzzy logic decision tree 48 operates by evaluating the input variables, namely the determined value(s) of characteristic quantity(ies) K₁, K₂, K₃, K₄, K₅ associated with the respective operational criterion CO, these input variables being quantitative or qualitative data, then converting them into degree of belonging values for the corresponding linguistic variables. For example, if the input variable is the indicator quantifying compliance with the flight plan or, for example, the takeoff delay indicator, the value of this variable is translated, in degree of belonging, to linguistic variables such as “low,” “medium,” or “high.”

The fuzzy logic decision tree 48 then uses fuzzy rules to evaluate these degrees of belonging and to make decisions. These rules are generally defined by experts in the field or by historical data. The fuzzy rules are typically represented in the form of “if . . . then” with linguistic variables.

Optionally, the fuzzy logic decision tree 48 uses inference methods to calculate the final output by combining the results of several rules. Such an inference method is the Mamdani method, for example, which uses the weighted average of the rules to calculate the output.

The fuzzy logic decision tree 48 then enables estimating the value of the corresponding operational criterion CO in uncertain or imprecise environments using linguistic concepts and fuzzy rules, rather than rigid binary rules.

Advantageously, the fuzzy logic decision tree 48 comprises at least one fuzzy inference system FIS₁, FIS₂, FIS₃, FIS₄, FIS₅ (FIS, Fuzzy Inference System), each fuzzy inference system FIS₁, FIS₂, FIS₃, FIS₄, FIS₅ being configured to receive at least one determined value of characteristic quantity K₁, K₂, K₃, K₄, K₅ as input and to deliver a unit evaluation value as output; for each fuzzy inference system FIS₁, FIS₂, FIS₃, FIS₄, FIS₅, a correspondence between input(s) and output being established by fuzzy logic; the value of the operational criterion CO thus being estimated from the unit evaluation value(s) calculated for the set of characteristic quantity(ies) associated with said operational criterion CO.

In the example of FIG. 2, the fuzzy logic decision tree 48 is thus represented in the form of a graph of fuzzy inference systems FIS1, FIS2, FIS3, FIS4, FIS5, each with an associated weighting coefficient α1, α2, α3, α4, α5. In this example, the fuzzy logic decision tree 48 includes five fuzzy inference systems FIS1, FIS2, FIS3, FIS4, FIS5, namely a first fuzzy inference system FIS1 with a first weighting coefficient α1, a second fuzzy inference system FIS2 with a second weighting coefficient α2, a third fuzzy inference system FIS3 with a third weighting coefficient α3, a fourth fuzzy inference system FIS4 with a fourth weighting coefficient α4, and a fifth fuzzy inference system FIS5 with a weighting coefficient α5.

In this example, the fuzzy inference systems are distributed over three levels, namely a lower level corresponding to the first, second, and third fuzzy inference systems FIS1, FIS2, FIS3, receiving the input variables, i.e. the determined value(s) of the set of characteristic quantity(ies) K1, K2, K3, K4, K5 associated with the corresponding operational criterion CO; an intermediate level corresponding to the fourth fuzzy inference system FIS4 connected to the output of the first and second fuzzy inference systems FIS1, FIS2; and an upper level corresponding to the fifth fuzzy inference system FIS5 connected to the output of the third and fourth fuzzy inference systems FIS3, FIS4, the fifth fuzzy inference system FIS5 thus being configured in this example to deliver the estimated value of the operational criterion CO at its output.

Each fuzzy inference system FIS1, FIS2, FIS3, FIS4, FIS5 is a structure that enables formalizing the fuzzy rules that govern the decision-making of the decision tree 48. Each fuzzy inference system FIS1, FIS2, FIS3, FIS4, FIS5 comprises one or more input variables, for example, each typically divided into a certain number of linguistic categories, called “fuzzy sets”; one or more belonging functions, namely mathematical functions assigning a degree of belonging value to each input for each fuzzy set; one or more fuzzy rules governing decision-making, typically in the form “If the input is in fuzzy set A AND the input is in fuzzy set B, then the output is in fuzzy set C”; one or more inference functions combining the degrees of belonging of the input fuzzy sets to determine the degrees of belonging of the output fuzzy sets; one or more output variables representing the final decision, each typically divided into a certain number of fuzzy sets, similarly to the input variables; and one or more aggregation functions combining the degrees of belonging of the output fuzzy sets to determine the final output value. The aggregation function is a weighted sum, for example.

The fuzzy logic decision tree 48 has been previously trained during a preliminary learning step of the artificial intelligence algorithm 46, from training data.

Advantageously, the preliminary learning of the artificial intelligence algorithm 46 is supervised learning. The skilled person will observe that the supervised learning is not direct. Indeed, the operator annotates a result while the artificial intelligence algorithm 26, in particular the fuzzy logic decision tree 48, takes characteristic quantities as input. To build the training base, it is therefore necessary to provide a set of contextualized results; then, for each result of this set, to evaluate the characteristic quantities; and finally, for each result of this set, to have it annotated by an operator expert in the operational semantics of the system.

The supervised learning of the fuzzy logic decision tree 48 begins with the collection of training input and output data. The input data is typically characteristics or attributes that describe a situation or problem, while the output data represents the expected results for each situation or problem. The logical rules of the fuzzy logic decision tree 48 are thus constructed from the training data.

The preliminary learning of the fuzzy logic decision tree 48 is preferably performed through the implementation of a genetic algorithm. For said learning by genetic algorithm, a set of individuals is created, each individual representing a potential fuzzy logic decision tree. Each decision tree is evaluated based on its accuracy in the decision-making, which is measured using a fitness function. The individuals with a higher fitness function are selected to reproduce and create offspring. The reproduction involves combining characteristics of the parents while adding some variation to encourage the exploration of new solutions. The created offspring are then subjected to a fitness evaluation to determine if they are better or worse than their parents. The best individuals are retained for the next generation, while the less performing ones are eliminated. This process is repeated for several generations until a satisfactory fuzzy logic decision tree is found. Once the genetic algorithm has converged towards a solution, the fuzzy logic decision tree 48 thus trained is used to make decisions from new input data. The fitness function calculates the average of the discrepancies between the output of the learning model and an operational semantic annotation, typically of a high level, for example. This fitness function must be minimized during the learning process.

According to a second variant, the artificial intelligence algorithm includes a radial basis function fuzzy network comprising at least one fuzzy inference system FIS1, FIS2, FIS3, FIS4, FIS5, each fuzzy inference system FIS1, FIS2, FIS3, FIS4, FIS5 being configured to receive at least one determined value of characteristic quantity K1, K2, K3, K4, K5 as input and to deliver a unit evaluation value as output; for each fuzzy inference system FIS1, FIS2, FIS3, FIS4, FIS5, a correspondence between input(s) and output being established by fuzzy logic; the value of the operational criterion CO thus being estimated from the unit evaluation value(s) calculated for the set of characteristic quantity(ies) associated with said operational criterion CO, said polynomial function representing said at least one operational criterion is equivalent to said at least one fuzzy inference system of said radial basis function fuzzy network.

In other words, the present invention, according to the first variant, proposes implementing a transition from a fuzzy logic decision tree, also called GFT (Generalized Fuzzy Tree), to a decision tree in polynomial form, as specifically described by Timothy J. Arnett in the document entitled “Iteratively Increasing Complexity During Optimization for Formally Verifiable Fuzzy Systems,” or, according to the second variant, to implement a transition from a fuzzy inference system of a fuzzy radial basis function network (artificial neural networks called radial basis and fuzzy function networks or FRBFNs (Fuzzy Radial Basis Function Networks), a solution for implementing such a transition being described in the patent application whose filing number is FR 2412499.

It should be noted that these documents only disclose how to determine a polynomial function from a fuzzy decision tree or from so-called radial basis artificial neural networks, but do not apply it to represent an operational criterion of said aircraft mission as proposed according to the present invention.

For example, consider the aircraft mission during which an aircraft is led to search for and find a diversion airport due to meteorological degradations, and that the operational criterion CO to be monitored is the safety of the trajectory flown, with this criterion, according to this example, depending on two characteristic quantities K1, the speed of the aircraft, for example, and K2, the ratio between the available fuel quantity and the necessary fuel quantity, for example.

Such an operational criterion to be monitored, corresponding to the safety S of the flown trajectory, is then expressed in the following polynomial form, according to the present invention, obtained according to a first variant from a fuzzy logic decision tree GFT illustrated by FIG. 2, or according to a second variant from a fuzzy inference system of a radial basis function fuzzy network FRBFN:

S=f(K1, K2), with f a polynomial function equivalent to the fuzzy inference system of a fuzzy logic decision tree GFT or a radial basis function fuzzy network FRBFN, with, for example, S=3−3*K1+1*K2.

The second determination module 24 is configured to determine, by partial derivative of said polynomial function, the impact of the variation of each characteristic quantity of said set associated with said operational criterion CO on the value of said operational criterion CO.

Returning to the above example of monitoring the operational criterion CO to be monitored corresponding to the safety S of the flown trajectory, by partial derivative, the second determination module 24 is able to identify (determine) the impact of the characteristic quantity K1, the speed of the aircraft, for example, and K2, the ratio between the available fuel quantity and the necessary fuel quantity, for example, on the safety S of the flown trajectory.

Indeed, according to this example, the second determination module 24 determines that

$$\frac{\partial S}{\partial K 1} = - 3 ,$$

which implies that when K1, the speed, for example, increases, the safety S decreases, and

$$\frac{\partial S}{\partial K 2} = 1 ,$$

which implies that when K2, the ratio between the available fuel quantity and the necessary fuel quantity, for example, increases, the safety S increases.

The return module 26 is configured to return the impact of each characteristic quantity, via a human-machine interface, to an operator of said aircraft, the value −3 for K1 and 1 for K2, for example, which then easily enables said operator of said aircraft to identify the causes of an increase or decrease in safety.

The characteristic quantity Ki, at the origin of the positive or negative variation of the operational criterion to be monitored, is thus identified.

It should be noted that, compared to the aforementioned document whose filing number is FR 2303810 where, by means of the weighting coefficients α1, α2, α3, α4, α5, it was only possible to identify which fuzzy inference system FIS was associated with an operational criterion variation, the present invention proposes to go further, via the associated polynomial function, and to further reduce the cognitive load of the operator by backpropagating to a higher level of refinement (i.e. in FIG. 2, descending to the lowest refinement level, that of the inputs Ki), that of the characteristic quantities Ki corresponding to the individual inputs of the fuzzy inference systems FIS of FIG. 2.

In other words, the present invention proposes to use a gradient technique identifying the modification of technical parameters (i.e. characteristic quantity, elements of the tactical situation) Ki (i.e. of “low level” as corresponding to the “low level” inputs of the fuzzy inference systems FIS) having an impact on an operational criterion to be monitored, and conducive to being the root cause of a modification of the value of said operational criterion to be monitored.

For example, for an operational criterion corresponding to comfort, according to the aforementioned document whose filing number is FR 2303810, a fuzzy logic decision tree comprising two fuzzy inference systems FIS corresponding to “comfort at destination” and “comfort during the flight”, respectively, would be conducive to being used and, according to this document, only the causal quantity between these two fuzzy inference systems FIS would be conducive to being determined, whereas according to the present invention, via the equivalent representation in polynomial function form and the application of partial derivative, it is possible to identify the Ki(s) at the origin of an anomaly of the monitored operational criterion.

Indeed, the impact of the variation of each characteristic quantity of said set associated with said operational criterion CO on the value of said operational criterion CO depends on the sign and value of the partial derivative associated with said characteristic quantity. Directly identifying the characteristic quantity Ki, source of anomaly in execution of the mission, is directly more “meaningful” for the operator as compared to the less precise identification of an involved fuzzy inference system FIS.

It should be noted that in the case of several characteristic quantities Ki associated with the same sign of partial derivative, the characteristic quantity Ki having the highest partial derivative value is the one that has the most impact on the considered operational criterion, among said characteristic quantities Ki associated with the same sign of partial derivative.

Optionally, the receipt module 28 of at least one piloting intention to be monitored and associated with said operational criterion CO, the aforementioned third determination module 30 are used to further reduce the cognitive load of the operator in the presence of the received piloting intention, for example.

For example, returning to the previous example concerning an operational criterion corresponding to comfort, the fuzzy inference system corresponding to “comfort at destination” C_{D} is, for example, equivalent to the polynomial function expressed by the following equation: C_{D}=1.55*K1*K2+0.14*K1−1.76*K2+0.63, with K1 the availability of hotel rooms and K2 the availability of food at the destination, K1 and K2 being known at each iteration implemented by the electronic device 20 for assisting in monitoring the mission status of at least one aircraft, with K1=0.5 and K2=1.0 at the current implementation time, for example. The partial derivative, with respect to K1 varying, with K2 constant is: 0.14+1.55*K2, while the partial derivative, with respect to K2 varying, with K1 constant, is: −1.76+1.55*K1, so that knowing K1 and K2, the partial derivative, with respect to K1 varying is then equal to 1.69 (K2 being equal to 1.0) and the partial derivative, with respect to K2 varying is then equal to −0.985 (K1 being equal to 0.5).

If the piloting intention to be monitored received by the receipt module 28 is to maximize comfort at the destination, with the partial derivative being negative, with respect to K2 varying, K2 then be reduced in order to maximize comfort at destination, while with the partial derivative being positive, with respect to K1 varying, K1 must be increased in order to maximize comfort at the destination.

According to this optional addition and this example, the return module 26 is therefore configured to return (i.e. signal/indicate) to the operator a recommended reduction of K2 and a recommended increase of K1 to satisfy the received piloting intention, and the operator (or another supervisory function), having knowledge of this return, will be able to make a decision on the Ki that they can optimize.

Optionally, the fourth determination module 32, configured to determine a discrepancy between a current value of the operational criterion CO and a previous value of said operational criterion CO, and the first identification module 34 enable taking advantage of the present invention, for example, in the presence of at least one development of the monitored operational criterion value, among the modification of the environment of the aircraft 10, change of the desired value of the operational criterion CO and an action of the pilot different from the one planned, by using the impact of each characteristic quantity to explain to the operator the root cause of said development.

Optionally, the construction and return module 36 and the second identification module 38 enable adding a visual representation and specifying trajectory portions impacted by said at least one of the characteristic quantities K1, K2, . . . , KN associated with said operational criterion CO, itself responsible for a discrepancy in said operational criterion CO.

More precisely, the construction and return module 36 is configured to construct and return a visual representation corresponding to the projection of the aircraft's trajectory in an M-dimensional space (such as a 2D two-dimensional space, a 3D three-dimensional space, or even a 4D four-dimensional space conducive to also taking into account the inclination of the aircraft), each point of which is associated with a cost value relative to said operational criterion, a correspondence being established beforehand between each cost value and the value(s) of each characteristic quantity of said set associated with said operational criterion CO.

The cost value for all points of the space is a spatial representation with a value (i.e. a floating number) for each point associated with a characteristic quantity (“mini map”-matrix or tensor depending on the considered space), and is used to project the trajectory only on the representation of the characteristic quantity Ki (for each operational criterion) that is impacted.

When the predetermined function g is differentiable and corresponds to the Hadamard product, for example, between the cost map MMi of cost i and the identity map of the trajectory, it is then possible to identify, by derivative: the pixels (with coordinates x and y) on the cost map at the origin of the development of the operational criterion value, and the critical trajectory portions passing through pixels having consequences on the value of our Ki and indirectly on the value of the operational criterion.

The georeferenced spatial identification implemented by the second identification module 38 is thus conducive to enabling identifying whether the aircraft passes through a dangerous cumulonimbus, for example, and the portion of the critical trajectory related to this danger responsible for a low value of the operational safety criterion.

The operation of the electronic device 20 for assisting in monitoring the mission status of said aircraft will now be described with reference to FIG. 3, representing a flowchart of the method 50 for assisting in monitoring the mission status of said aircraft according to the invention, implemented by the electronic device 20 for assisting in monitoring the mission status of said aircraft.

During a first step 52, the electronic device 20 for assisting in monitoring the mission status of said aircraft determines D_F a polynomial function representing said at least one operational criterion, each monomial of which is a product of constants and/or variables, each variable being a characteristic quantity K1, K2, . . . , KN of a set of N characteristic quantity(ies) associated with said operational criterion CO.

Then, during a step 54, the electronic device 20 for assisting in monitoring the mission status of said aircraft determines D_Imp, by partial derivative, said polynomial function, determination of the impact of the variation of each characteristic quantity of said set associated with said operational criterion CO on the value of said operational criterion CO.

Next, during a step 56, the electronic device 20 for assisting in monitoring the mission status of said aircraft returns Rest-Imp of the impact of each characteristic quantity, via a human-machine interface, to an operator of said aircraft, conducive to using said impact to identify at least one source of execution anomaly of said mission.

According to an optional addition (represented in dotted lines), during a step 58, the electronic device 20 for assisting in monitoring the mission status of said aircraft receives R_Int at least one piloting intention to be monitored and associated with said operational criterion CO, specifically via the aforementioned human-machine interface.

According to this optional addition, during a step 60, the electronic device 20 for assisting in monitoring the mission status of said aircraft determines D_V, based on said impact (from step 54) of each characteristic quantity of said set associated with said operational criterion (CO) and said at least one intention, the type of variation of said characteristic quantity to be monitored according to a reference variation value, the type of variation being an increase or decrease.

Still according to this optional addition, during a step 62, the electronic device 20 for assisting in monitoring the mission status of said aircraft returns Rest-V, via said human-machine interface, to an operator of said aircraft, said type of variation to be returned to the operator for each characteristic quantity of said set associated with said operational criterion CO.

According to another optional addition (conducive to being combined with the previous optional addition), during a step 64, the electronic device 20 for assisting in monitoring the mission status of at least one aircraft determines D_E_{c} a discrepancy between a current value Vs of the operational criterion CO and a previous value Vₑ of said operational criterion CO, each current or previous value of said operational criterion CO being obtained from each determined value of characteristic quantity K1, K2, . . . , KN associated with said operational criterion CO and through the implementation of an artificial intelligence algorithm.

According to this other optional addition, the electronic device 20 for assisting in monitoring the mission status of at least one aircraft, during a step 66, identifies ID_G, from the value of said discrepancy, and said impact (from step 54) of each characteristic quantity of said set associated with said operational criterion CO at least one of the characteristic quantities K1, K2, . . . , KN associated with said operational criterion CO conducive to being responsible for said discrepancy Ec.

According to yet another optional addition (conducive to being combined with the two previous optional additions), the electronic device 20 for assisting in monitoring the mission status of at least one aircraft, during a step 68, constructs C_Rᵥ and returns a visual representation corresponding to the projection of the aircraft's trajectory in an M-dimensional space, each point of which is associated with a cost value relative to said operational criterion (and, if applicable, taking into account the piloting intention to be monitored received during step 58), a correspondence being established beforehand between each cost value and the value(s) of each characteristic quantity of said set associated with said operational criterion CO.

According to this other optional addition, the electronic device 20 for assisting in monitoring the mission status of at least one aircraft, during a step 70, identifies ID_P, from said visual representation, trajectory portions impacted by said at least one of the characteristic quantities K1, K2, . . . , KN associated with said operational criterion CO conducive to being responsible for said discrepancy.

The skilled person will understand that the invention is not limited to the described embodiments, nor to the specific examples of the description, with the embodiments and variants mentioned above conducive to being combined with each other to generate new embodiments of the invention.

The present invention thus enables informing the aircraft operator of the impact of each characteristic quantity on an operational criterion to be monitored, with each operational criterion being chosen from the group consisting of: safety, punctuality, comfort, and ecology, for example.

Such impactful information is also capable of additionally being used to automatically and directly identify the root cause of n development (i.e. variation) of the monitored operational criterion, which effectively relieves the cognitive load of the operator.

1. A method for assisting in monitoring the mission status of at least one aircraft, through the monitoring of at least one operational criterion of a mission of said at least one aircraft during the execution of said mission,
the method being implemented by an electronic device for assisting in monitoring the mission status of said at least one aircraft, and comprising, for each operational criterion, the following steps:
determination of a polynomial function representing said at least one operational criterion, each monomial of which is a product of constants and/or variables, each variable being a characteristic quantity of a set of N characteristic quantity(ies) associated with said operational criterion;
by partial derivative of said polynomial function, determination of the impact of the variation of each characteristic quantity of said set associated with said operational criterion on the value of said operational criterion; and
return of the impact of each characteristic quantity, via a human-machine interface, to an operator of said at least one aircraft, conducive to using said impact to identify at least one source of execution anomaly of said mission.

2. The method according to claim 1, wherein the impact of the variation of each characteristic quantity of said set associated with said operational criterion on the value of said operational criterion depends on the sign and value of the partial derivative associated with said characteristic quantity.

3. The method according to claim 1, wherein the method further comprises:
the receipt of at least one piloting intention to be monitored and associated with said operational criterion;
based on said impact of each characteristic quantity of said set associated with said operational criterion and said at least one intention, the determination of the type of variation of said characteristic quantity to be monitored according to a reference variation value, the type of variation being an increase or decrease; and
the return, via said human-machine interface, to an operator of said at least one aircraft, of said type of variation to be returned to the operator for each characteristic quantity of said set associated with said operational criterion.

4. The method according to claim 1, wherein the method further comprises:
the determination of a discrepancy between a current value of the operational criterion and a previous value of said operational criterion, each current or previous value of said operational criterion being obtained from each determined value of characteristic quantity associated with said operational criterion and through the implementation of an artificial intelligence algorithm; and
from the value of said discrepancy and said impact of each characteristic quantity of said set associated with said operational criterion, identification of at least one of the characteristic quantities associated with said operational criterion conducive to being responsible for said discrepancy.

5. The method according to claim 4, wherein the artificial intelligence algorithm includes a fuzzy logic decision tree, the fuzzy logic decision tree comprising at least one fuzzy inference system, each fuzzy inference system being configured to receive at least one determined value of characteristic quantity as input and to deliver a unit evaluation value as output; for each fuzzy inference system, a correspondence between input(s) and output being established by fuzzy logic; the value of the operational criterion then being estimated from the unit evaluation value(s) calculated for the set of characteristic quantity(ies) associated with said operational criterion,
and wherein said polynomial function representing said at least one operational criterion is equivalent to said at least one fuzzy inference system of said fuzzy logic decision tree.

6. The method according to claim 4, wherein the artificial intelligence algorithm comprises a radial basis function fuzzy network includes at least one fuzzy inference system, each fuzzy inference system being configured to receive at least one determined value of characteristic quantity as input and to deliver a unit evaluation value as output; for each fuzzy inference system, a correspondence between input(s) and output being established by fuzzy logic; the value of the operational criterion then being estimated from the unit evaluation value(s) calculated for the set of characteristic quantity(ies) associated with said operational criterion,
and wherein said polynomial function representing said at least one operational criterion is equivalent to said at least one fuzzy inference system of said radial basis function fuzzy network.

7. The method according to claim 4, wherein the method further comprises:
the construction and return of a visual representation corresponding to the projection of the at least one aircraft's trajectory in an M-dimensional space, each point of which is associated with a cost value relative to said operational criterion, a correspondence being established beforehand between each cost value and the value(s) of each characteristic quantity of said set associated with said operational criterion;
from said visual representation, identification of trajectory portions impacted by said at least one of the characteristic quantities associated with said operational criterion conducive to being responsible for said discrepancy.

8. A computer program, including software instructions which, when executed by a computer, implement the method according to claim 1.

9. An electronic device for assisting in monitoring the mission status of at least one aircraft, through the monitoring of at least one operational criterion of a mission of said at least one aircraft during the execution of said mission, the device comprising:
a first determination module, configured to determine a polynomial function representing said at least one operational criterion, each monomial of which is a product of constants and/or variables, each variable being a characteristic quantity of a set of N characteristic quantity(ies) associated with said operational criterion;
a second determination module, configured to determine, by partial derivative of said polynomial function, the impact of the variation of each characteristic quantity of said set associated with said operational criterion on the value of said operational criterion;
a return module, configured to return the impact of each characteristic quantity, via a human-machine interface, to an operator of said at least one aircraft, conducive to using said impact to optimize the piloting of said at least one aircraft.

10. An aircraft comprising an electronic device for assisting in piloting the aircraft, the piloting assistance device being in accordance with the electronic device of claim 9.
